(19) United States
(12) Patent Application Publication
(10) Pub. No.: US 2018/0251256 A1
(43) Pub. Date: Sep. 6, 2018

(54) BENTO BOX AND ITS FOOD COMPARTMENT DIVIDER

(71) Applicant: FC Meyer Packaging LLC, Norwalk, CT (US)

(72) Inventor: Matthew Arthur Baryshyan, Stormville, NY (US)

(73) Assignee: FC Meyer Packaging LLC, Norwalk, CT (US)

(21) Appl. No.: 15/446,126

(22) Filed: Mar. 1, 2017

(51) Int. Cl. B65D 5/49; B65D 5/42; B65D 5/56; B31D 5/00

(52) U.S. Cl. CPC B65D 5/48034; B65D 5/4266; B31B 2217/10; B31D 5/0013; B31B 11/00; B65D 5/563

(57) ABSTRACT

A divider for a bento box—the divider has three flat food compartment regions and two folded portions. One of the regions is separated from the two remaining regions by the folded portions. The two folded portions each have three fold lines with a respective tab at one of the fold lines inserted into a respective slot at another of the fold lines. One of the two folded portions has a pair of aligned slots and the other of the two folded portions has a further tab inserted into the pair of slots. The lid of the bento box may be folded closed and has flaps that engage each other and leave room underneath to retain chopsticks in position.

### BACKGROUND OF THE INVENTION

### Field of the Invention

The invention relates to a bento box and its food compartment divider that gets placed into the bent box. The lid of the bento box is folded in a manner that enables insertion and retention of chopsticks. The divider allows the standard take out package to have multiple uses. Without the divider, the package is an entre sized take out package capable of containing a protein, starch and vegetable. With the bento divider, the package is converted into a classic bento box that has the traditional dividers for rolls, dumplings, salad, rice and protein. This eliminates the need for two separate packages, which saves space and money.

### Description of Related Art

According to Wikipedia ay https://en.wikipedia.org/wiki/Bento:

Bento is a single-portion takeout or home-packed meal common in Japanese cuisine. A traditional bento holds rice, fish or meat, with pickled or cooked vegetables, usually in a box-shaped container. Containers range from disposable mass-produced to hand-crafted lacquerware.

There are similar forms of boxed lunches in Asian countries including the Philippines (Baon), Korea (Dosirak), Taiwan (Biandang), and India (Tiffin). Also, Hawaiian culture has adopted localized versions of bento featuring local tastes after over a century of Japanese influence in the islands.

Conventionally, bento boxes are shipped in an assembled condition or with individual food compartment trays that are to be inserted individually into the bento box. If a divider is provided instead of individual food compartment trays, then the divider has its own shaped food compartments and thus is not shipped in a flattened state. Often, the bento box and the divider are formed together is a single take out package, thereby not only prohibiting the feasibility of flattening them for shipment and storage, but also preventing such a take out package from having multiple uses.

It is desired to conserve space for shipping bento boxes with their dividers and for storage until they are needed for use. Such may be achieved by flattening the dividers and the boxes for shipment and storage. It is further desired to provide multiple uses for a take out package that has a bento box and divider by enabling their separation from each other and thus their independent use.

### SUMMARY OF THE INVENTION

One aspect of the invention resides in a bento box divider that is assembled by forming three flat regions and two folded regions by folding two fold lines to form the two folded regions and inserting a center tab into two slots, inserting an end tab into an end slot and inserting a further end tab into a further end slot. One of the flat regions, which is the smallest in size of the three, is separated from the other two flat regions by respective ones of the two folded regions.

Another aspect resides in a bento box whose lid is folded together into a closed condition with four flaps that leave enough room to accommodate insertion of chopsticks and retention of same under the flex of the flaps.

### BRIEF DESCRIPTION OF THE DRAWINGS

For a better understanding of the present invention, reference is made to the following description and accompanying drawings, while the scope of the invention is set forth in the appended claims.

FIG. 1 is a schematic diagram of a blank in accordance with the invention that may be folded into a divider for a bento box.

FIG. 2 is the folded blank of FIG. 1 that forms the divider for the bento box.

FIG. 3 is an open bento box containing the divider of FIG. 2.

FIG. 4 is the open bento box with the divider of FIG. 3 with food In the compartments formed by the divider.

FIG. 5 is a top view of the bento box of FIGS. 3 and 4 but closed with the lids folded and retaining chopsticks.

### DESCRIPTION OF THE PREFERRED EMBODIMENT

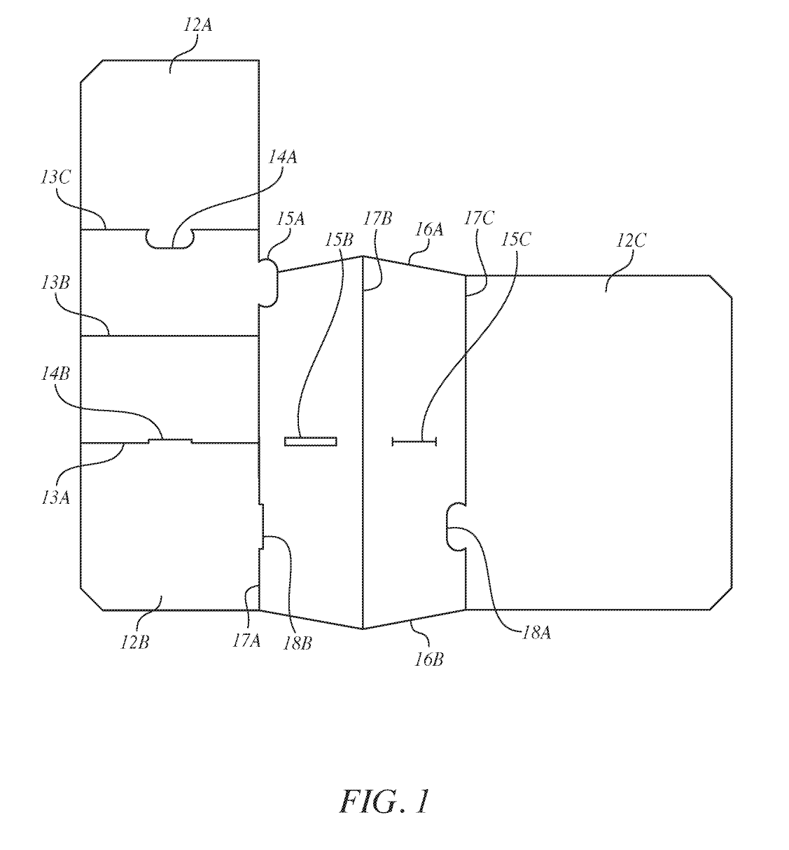

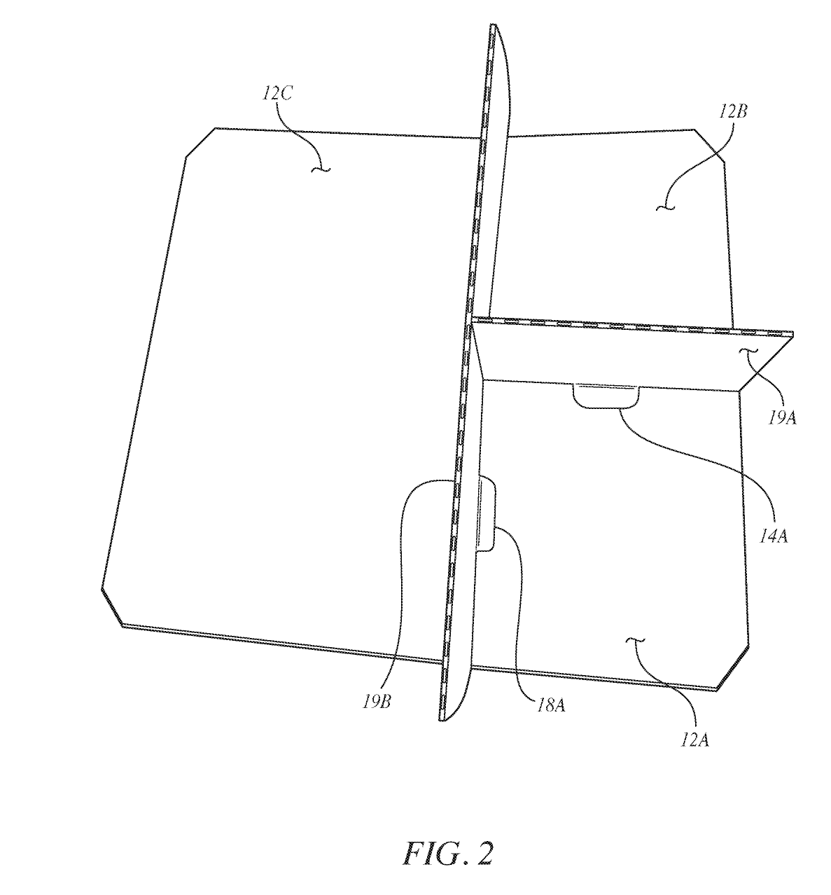

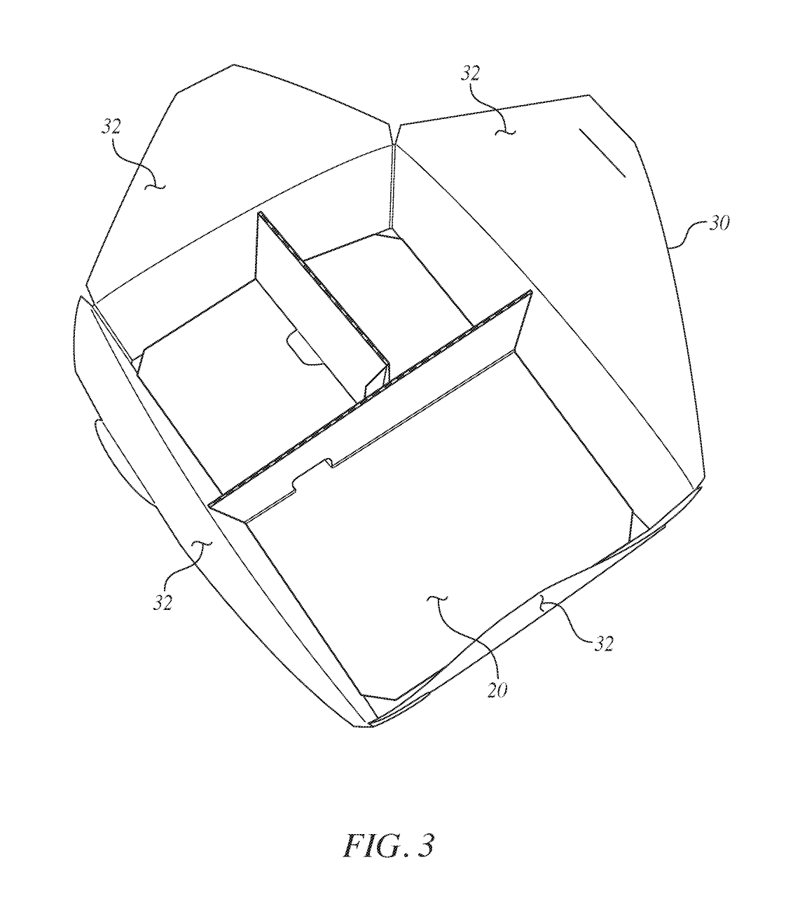

Turning to FIG. 1, the bento box divider of the present invention my be made from a die-cut board blank 10 by folding in accordance with the following steps:
Step 1: Locate coated side of the die-cut board blank 10, hold up.
Step 2: Fold upward along the fold lines 13B and 17B
Step 3: Fold downward along the fold lines 13A, 13C, 17A, 17C
Step 4: Holding fold lines 13B and 17B upward in their folded condition, slide the center tab 15A into the center slots 15B, 15C
Step 5: Slide the bottom tab 14A (by fold line 13C) into the bottom slot 14B
Step 5: Slide the bottom tab 18A (by fold line 17C) into the bottom slot 18B. The result is the folded divider 20 of FIG. 2 that has three flat regions 12A, 12B and 12C with the flat region 12B separated from the flat regions 12A, 12C by folded portions 19A, 19B, respectively.
Step 6: Put the folded divider 20 of FIG. 2 in a bento box 30 of FIG. 3.

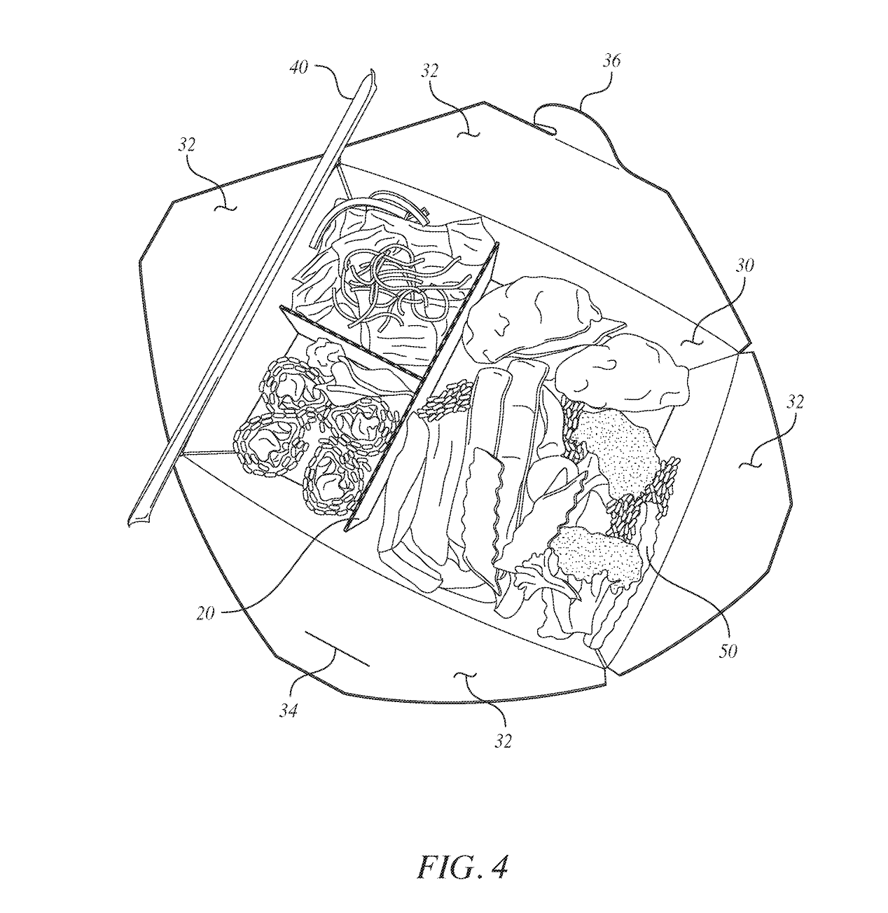

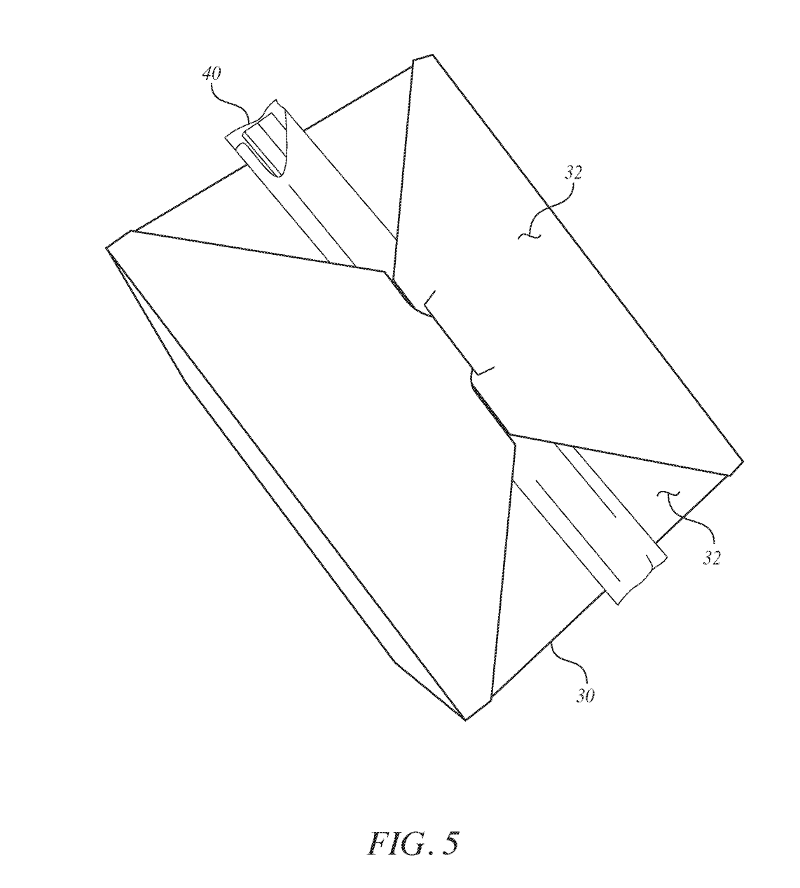

One may fill the compartments formed by the divider 20 over the flat regions 12A, 12B, 12C with rolls, dumplings and rice or salad combination 50 as shown in FIG. 4. The bento box 30 has a bottom (not shown), sidewalls and four folding flaps 32 that form the lid that is shown open in FIG. 4 from its closed condition of FIG. 5. The folded flaps 32 in their closed position of FIG. 5 give enough room to accommodate insertion of a sleeve with chopsticks 40 and retain them under flex of the flaps 32 as shown. Preferably, the bento box is formed from a board blank in a conventional manner with two sidewalls glued to each other. Preferably, the lid and bottom are formed in a like manner with flaps so that the bento box may be flattened for shipment and storage and then erected into a box configuration by closing the flaps that form the bottom of the box.

Indeed, the unique fold and lock lid of the bento box 30 offers a perfect place to slide in the sleeve with chopsticks 40 for a finished look as shown in FIG. 5. One of the flaps 32 has a slot 34 and another of the flaps 32 has a hooked tab 36 that fits into the slot 34 to retain the flaps in a closed position when those two flaps are folded over the remaining two flaps 32.

Turning to FIG. 1, preferably, the die-cut board blank 10 is made of a paperboard that is die cut, scored and double-sided coated. The coating is 100% water-based, recyclable and compostable within 90 days in a properly managed landfill. A conventional perfecting press may be used to shape the divider and provide the score lines and coat both sides. Either fibers of the paperboard itself may be treated to prevent unhealthy food contamination when coming into contact with food and/or the paperboard may be coated with an appropriate coating that prevents such unhealthy contamination when the coating comes into contact with food.

U.S. Pat. No. 9,498,074 whose contents are incorporated herein by reference with respect to its discussions under the headings Take-Out Packaging, 100% Recycled Uncoated Paperboard, F.C. Meyer Packaging Meyercote Coating Conventional Manufacture of Paperboard Box, Presses. Such discussions apply to the choice of materials and manufacture of the board blank in accordance with the invention that is to be folded into a bento box divider and that resists unhealthy contamination when coming into contact with food. The coating applied to the board blank preferably prevent contamination of food that it comes into contact with and is stain-resistant to prevent staining from grease and water.

With respect to FIGS. 1-3, the three flat regions 12A, 12B, 12C of the bento box divider 20 are of different dimensions and two folded regions 24A, 24B of different dimensions. The flat region 12B is separated from the flat region 12A by the folded region 19A and from the flat region 12C by the folded region 19B. The flat region 12B may be the smallest in size of the three flat regions. The folded region 19A may be smaller than the folded region 19B. Indeed, the length of the folded region 19B may be longer than the length of the folded region 19A and may be longer than the width of the folded region 19A in its unfolded condition of FIG. 1.

The folded region 19A has three fold lines 13A, 13B, and 13C. The folded region 19B has three fold lines 17A, 17B, and 17C. Fold lines 13A and 17A each have a respective slot 14B, 18B. Fold lines 13C and 17C each have a respective tab 14A, 18A that aligns with and fits through the respective slot 13C or 27C as applicable when the folded regions 19A, 19B (FIG, 2) are in their folded condition.

The folded region 19B also has the pair of aligned center slots 15B, 15C (best seen in FIG. 1). An edge of the folded region 19A has the center tab 15A that fits into the pair of aligned slots 15B, 15C when both of the folded regions 19A, 19B are in their folded conditions.

The edges around each of the flat regions 12A, 12B and 12C are straight although one of the corners of flat regions 12A and 12B and both of the corners of flat region 12C may have a 45 degree angle instead of a 90 degree angle as shown in FIG. 1. The remaining corner of flat region 12A may be ninety degrees. Thus, the flat region 12B has two edges perpendicular to each other and the remaining flat regions 12A, 12C each have two respective edges that are parallel to each other and perpendicular to a remaining third edge.

The folded region 19B, however, as better seem in FIG. 1, has two pairs of angled edges 16A, 16B that converge outwardly in opposite directions from each other.

While the foregoing description and drawings represent the preferred embodiments of the present invention, it will be understood that various changes and modifications may be made without departing from the scope of the present invention.

1. food compartment divider, comprising:
a folded board blank having three spaced apart flat regions, one of the three spaced apart flat regions being separated from a remaining two of the three spaced apart regions by respective folded portions, each of the respective folded portions having a respective tab and slot that are aligned with the respective tab inserted into the respective slot, one of the respective folded portions having a further tab, a remaining one of the respective folded portions having a pair of slots aligned with each other, the further tab being aligned with the pair of slots and inserted into the pair of slots so as to form an assembled food compartment divider.

2. The food compartment divider of claim 1, wherein each of the three spaced apart flat regions and two edges substantially perpendicular to each other, two of the three spaced apart flat regions have a further edge that is substantially parallel to an associated one of the two edges and substantially perpendicular to an associated remaining one of the two edges.

3. The food compartment divider of claim 1, wherein one of the folded portions has one pair of edges that incline outwardly to converge toward each other and has a further pair of edges that incline outwardly to converge toward each other, the one pair of edges and the further pair of edges inclining outwardly in opposite directions relative to each other.

4. The food compartment divider of claim 1, where the three spaced apart flat regions are of different dimensions with the one of the three spaced apart flat regions being smallest in dimension relative to the remaining two of the three spaced apart regions.

5. The food compartment divider of claim 1, where one of the respective folded portions being longer than a remaining one of the respective folded portions.

6. The food compartment divider of claim 5, wherein the remaining one of the respective folded portions as a width dimension with in an unfolded condition, the one of the respective folded portions is longer than the width dimension of the remaining one of the respective folded portions in the unfolded condition.

7. The food compartment divider of claim 1, wherein the respective folded portions each have three fold lines with two of the fold lines separating the one of the three spaced apart flat regions from associated ones of the remaining two of the three spaced apart regions, one of the respective tab and slot being at respective ones of the two of the fold lines that are associated with the one of the folded portions, a remaining one of the respective tab and slot being at respective ones of the two of the fold lines that are associated with the remaining one of the folded portions.

8. The food compartment divider of claim 1, wherein the respective folded portions each have three fold lines with two of the fold lines separating the one of the three spaced apart flat regions from associated ones of the remaining two of the three spaced apart regions, the three fold lines of the remaining one of the folded portions being arranged so that in the folded condition, the pair of slots align with each other.

9. The food compartment divider of claim 1, wherein the folded board blank is made of paperboard, the paperboard having post-consumer waste content paper selected from the group consisting of mixed paper, retired books, magazines, newspaper, corrugated boxes, and any combination thereof; and
an anti-staining coating on the paperboard for preventing staining from contact with grease and water.

10. The food compartment divider of claim 1, wherein the folded board blank is made of paperboard, the paperboard having post-consumer waste content paper selected from the group consisting of mixed paper, retired books, magazines, newspaper, corrugated boxes, and any combination thereof, the paperboard having treated fibers with sufficient potency at time of treatment to kill off bacteria residing in the fibers.

11. The food compartment divider of claim 1 in combination with a bento box in which is inserted the assembled food compartment divider, the bento box having a base, walls and a lid, the walls being between the base and the lid, the lid having a plurality of flaps that fold together into a closed position from an open position, the flaps having formations that retain the flaps in the closed position and that provide a gap to accommodate insertion and retention of a sleeve with chopsticks.

12. A method of assembly of a food compartment divider, comprising the steps of:
providing a board blank that has fold lines;
folding the fold lines to form two respective folded regions and leaving three spaced apart flat regions, one of the three spaced apart flat regions being separated from a remaining two of the three spaced apart regions by the respective folded portions, the respective folded portions each having a respective tab and slot, one of the respective folded portions having a further tab, a remaining one of the respective folded portions having a pair of slots;
aligning the further tab with the pair of slots and inserting the further tab into the pair of slots; and
aligning the respective tab with the respective slot for each of the respective folded portions and inserting the respective tab into the respective slot for each of the respective folded portions, whereby an assembled bento box divider arises after completion of all of the steps.

13. The method of claim 12, wherein the folded board blank is made of paperboard, the paperboard having post-consumer waste content paper selected from the group consisting of mixed paper, retired books, magazines, newspaper, corrugated boxes, and any combination thereof; and
preventing staining from contact with grease and water with an anti-staining costing on the paperboard.

14. The method of claim 12, wherein the folded board blank is made of paperboard, the paperboard having post-consumer waste content paper selected from the group consisting of mixed paper, retired books, magazines, newspaper, corrugated boxes, and any combination thereof, the paperboard having treated fibers with sufficient potency at time of treatment to kill off bacteria residing in the fibers.

15. The method of claim 12 in combination with inserting the assembled food compartment divider into a bento box, the bento box having a base, walls and a lid, the walls being between the base and the lid, the lid having a plurality of flaps; and
folding the flaps together into a closed position and retaining the flaps in the closed position via flap formations that engage each other, the retained flaps giving rise to a gap; and
inserting a sleeve with chopsticks into the gap and retaining same in position by the flaps.

16. The food compartment divider of claim 1 in combination with a box in which is inserted the assembled food compartment divider, the box having a base and walls that extend from the base.

17. The method of claim 12 in combination with inserting the assembled food compartment divider into a box, the box having a base and walls that extend from the base.
